(19) United States
(12) Patent Application Publication
(10) Pub. No.: US 2026/0072455 A1
(43) Pub. Date: Mar. 12, 2026

(54) CONTRACTING MEMBER STATE MONITORING AND/OR POSITION CONTROL

(71) Applicant: Toyota Motor Engineering & Manufacturing North America, Inc., Plano, TX (US)

(72) Inventors: Michael Paul Rowe, Pinckney, MI (US); Erin J. Rutledge, Tipton, MI (US); Xintong Deng, Plymouth, MI (US); Yufei Zhu, Ypsilanti, MI (US); Jaime N. Moore, Ann Arbor, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/324,822

(22) Filed: Sep. 10, 2025

Related U.S. Application Data
(60) Provisional application No. 63/692,853, filed on Sep. 10, 2024.

(51) Int. Cl. G05D 5/06; B60N 2/02

(52) U.S. Cl. CPC G05D 5/06; B60N 2/0248; B60N 2/0268

(57) ABSTRACT

A state of a contracting member (e.g., a shape memory material member) in an actuator can be monitored. When activated, the actuator can be configured to morph into an activated configuration in which a dimension of the actuator increases. A sensor can be configured to acquire sensor data. The contracting member can operatively engage the sensor. A processor can be operatively connected to monitor a state of the shape memory material member based on the sensor data.

### CROSS-REFERENCE TO RELATED APPLICATIONS

This application claims the benefit of U.S. Provisional Application No. 63/692,853, filed on Sep. 10, 2024, which is incorporated herein by reference in its entirety.

### FIELD

The subject matter described herein relates in general to actuators and, more particularly, to contracting member-based actuators.

### SUMMARY

In one respect, the present disclosure is directed to a system. The system can include an actuator configured to morph, when activated, into an activated configuration in which a dimension of the actuator increases. The actuator can include a contracting member. The system can include a sensor configured to acquire or output sensor data. The contracting member can operatively engage the sensor. The system can include a processor operatively connected to monitor a state of the contracting member based on the sensor data.

In another respect, the present disclosure is directed to a method of monitoring a state of a contracting member used in an actuator. The contracting member can operatively engage a sensor. The method can include causing the actuator to morph into an activated configuration. The method can include monitoring a state of the contracting member using sensor data from the sensor. The method can include controlling, based on the sensor data, an activated state of the actuator and/or a position of the actuator.

### BACKGROUND

Some motor vehicles have actuators in one or more portions of a vehicle seat. These actuators can provide a haptic effect to a seat occupant. Such an effect can provide support and/or comfort to a seat occupant.

### BRIEF DESCRIPTION OF THE DRAWINGS

FIG. 1 shows an example of a system for contracting member position control and/or state monitoring.

FIG. 2 is an example of a system for contracting member position control and/or state monitoring.

FIG. 3 is an example of a control scheme for a system for contracting member position control and/or state monitoring.

FIG. 4 is an example of a method of monitoring and/or controlling a state of a contracting member.

FIG. 5A-5C is a first example of an actuator.

FIGS. 6A-6B is a second example of an actuator.

FIGS. 7A-7B is a third example of an actuator.

FIG. 8 is a fourth example of an actuator.

FIG. 9A-9B is a fifth example of an actuator.

### DETAILED DESCRIPTION

Some actuators used in vehicles use shape memory alloys for actuation. Shape memory alloys can be prone to overstress and/or overheating, which can lead to a reduced life and/or effectiveness of the actuators. Further, shape memory alloy actuators typically operate between a non-activated state and a fully actuated state based on the supply of electric power. Attempts to control the position of a shape memory alloy actuator using model-based estimation have not delivered consistent results.

Accordingly, arrangements described herein are directed to monitoring the state of a contracting member and/or position control of a contracting member-based actuator. Such monitoring and/or controlling can be based on sensor data from a sensor that is operatively engaged by the contracting member.

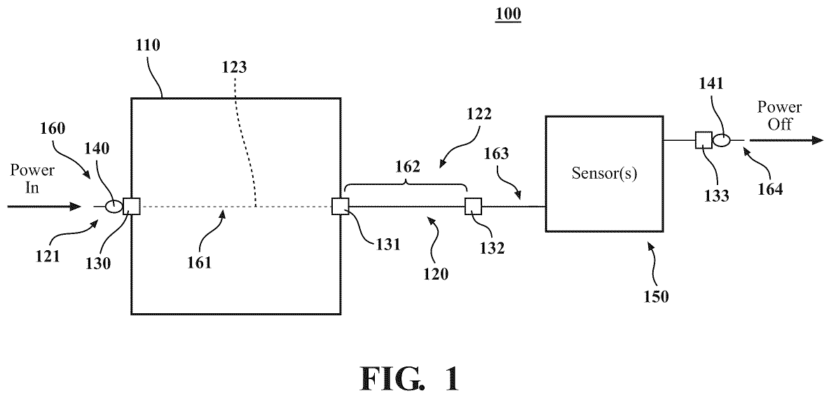

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

FIG. 1 shows an example of a system 100 for contracting member position control and/or state monitoring. The system 100 can include an actuator 110. The actuator 110 is represented generally as there are various suitable actuators that can work with arrangements herein. When activated, the actuator is configured to morph into an activated configuration in which a dimension (e.g., a height) of the actuator increases.

The actuator 110 can include one or more contracting members. The contracting member(s) can be any structure that, when activated, is configured to shrink in at least one dimension (e.g., length). In one or more arrangements, the contracting member(s) can be one or more shape memory material members 120, one or more active material members, or one or more memory material members. For convenience, the following description will be made in connection with the contracting member being a shape memory material member 120. However, it will be understood that the contracting member is not limited to being a shape memory material member.

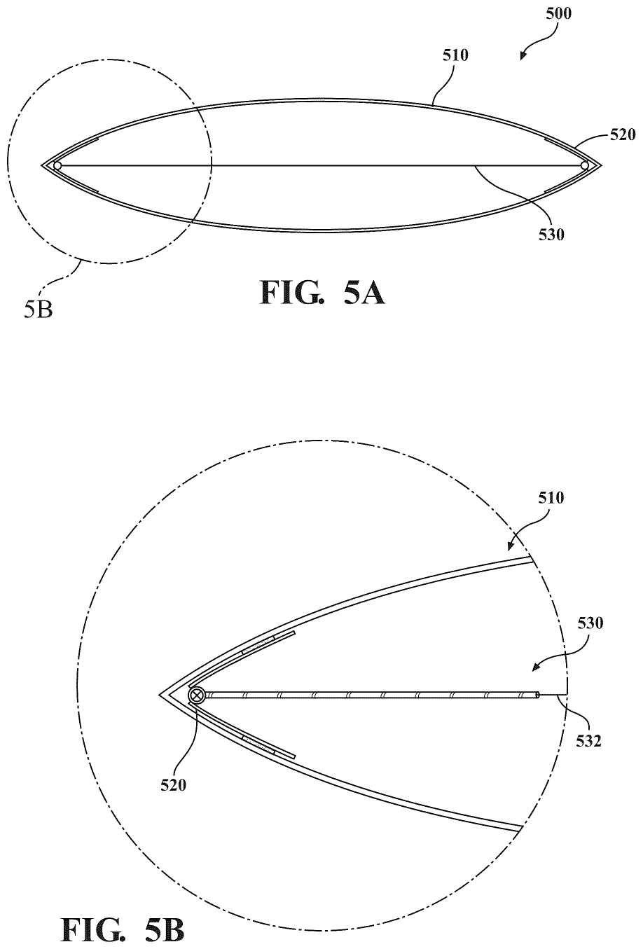

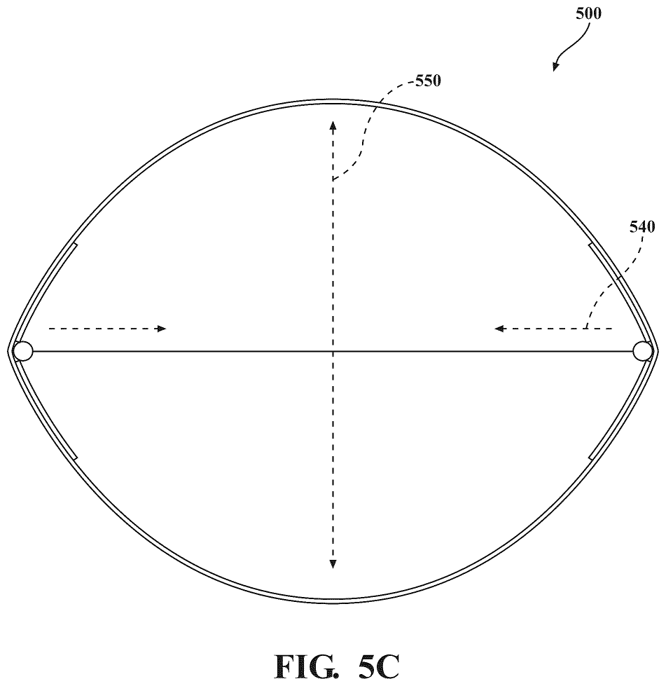

When an activation input is provided to the shape memory material member 120, the shape memory material member 120 can contract, thereby causing the actuator to morph into an activated configuration in which a dimension height of the actuator increases. In some arrangements, the contracting member can be a shape memory material member, which can include shape memory alloys and shape memory polymer. As an example, the contracting member can be a shape memory alloy wire. Various non-limiting examples of suitable actuators are shown in FIGS. 5-9, and they will be described in greater detail herein.

The phrase “shape memory material” includes materials that changes shape when an activation input is provided to the shape memory material and, when the activation input is discontinued, the material substantially returns to its original shape. Examples of shape memory materials include shape memory alloys (SMA) and shape memory polymers (SMP).

In one or more arrangements, the shape memory material members can be shape memory material wires. As an example, the shape memory material members can be shape memory alloy wires. Thus, when an activation input (i.e., heat) is provided to the shape memory alloy wire(s), the wire(s) can contract. Shape memory alloy wire(s) can be heated in any suitable manner, now known or later developed. For instance, shape memory alloy wire(s) can be heated by the Joule effect by passing electrical current through the wires. In some instances, arrangements can provide for cooling of the shape memory alloy wire(s), if desired, to facilitate the return of the wire(s) to a non-activated configuration. Of course, it will be appreciated that the activation input can be provided to the shape memory alloy wire(s) in other ways. For example, heated air can be blown on the shape memory alloy wire(s).

The wire(s) can have any suitable characteristics. For instance, the wire(s) can be high temperature wires with austenite finish temperatures from about 80 degrees Celsius to about 110 degrees Celsius. The wire(s) can have any suitable diameter. For instance, the wire(s) can be from about 0.2 millimeters (mm) to about 0.7 mm, from about 0.3 mm to about 0.5 mm, or from about 0.375 millimeters to about 0.5 millimeters in diameter. In some arrangements, the wire(s) can have a stiffness of up to about 70 gigapascals. The pulling force of SMA wire(s) can be from about 150 MPA to about 400 MPa. The wire(s) can be configured to provide an initial moment of from about 300 to about 600 N·mm, or greater than about 500 N·mm, where the unit of newton millimeter (N·mm) is a unit of torque (also called moment) in the SI system. One newton meter is equal to the torque resulting from a force of one newton applied perpendicularly to the end of a moment arm that is one meter long. In various aspects, the wire(s) can be configured to transform in phase, causing the shape memory material members to be moved from non-activated position to an activated position in about 3 seconds or less, about 2 seconds or less, about 1 second or less, or about 0.5 second or less.

The wire(s) can be made of any suitable shape memory material, now known or later developed. Different materials can be used to achieve various balances, characteristics, properties, and/or qualities. As an example, an SMA wire can include nickel-titanium (Ni—Ti, or nitinol). One example of a nickel-titanium shape memory alloy is FLEXINOL, which is available from Dynaolloy, Inc., Irvine, California. As a further example, the SMA wires can be made of Cu—Al—Ni, Fe—Mn—Si, or Cu—Zn—Al.

The SMA wire can be configured to increase or decrease in length upon changing phase, for example, by being heated to a phase transition temperature T_{SMA}. Utilization of the intrinsic property of SMA wires can be accomplished by using heat, for example, via the passing of an electric current through the SMA wire in order provide heat generated by electrical resistance, in order to change a phase or crystal structure transformation (i.e., twinned martensite, detwinned martensite, and austenite) resulting in a lengthening or shortening the SMA wire. In some implementations, during the phase change, the SMA wire can experience a decrease in length of from about 2 to about 8 percent, or from about 3 percent to about 6 percent, and in certain aspects, about 3.5 percent, when heated from a temperature less than the T_{SMA} to a temperature greater than the T_{SMA}.

The SMA wire can have a critical temperature. Once the critical temperature is reached, the SMA wire cannot produce any more force. Thus, if the SMA wire is heated above the critical temperature, it cannot produce any more force. This inherent property of the SMA wire can be leveraged according to arrangements described herein.

Other active materials may be used in connection with the arrangements described herein. For example, other shape memory materials may be employed. Shape memory materials, a class of active materials, also sometimes referred to as smart materials, include materials or compositions that have the ability to remember their original shape, which can subsequently be recalled by applying an external stimulus, such as an activation signal.

While the shape memory material members are described, in some implementations, as being wires, it will be understood that the shape memory material members are not limited to being wires. Indeed, it is envisioned that suitable shape memory materials may be employed in a variety of other forms, such as sheets, plates, panels, strips, cables, tubes, or combinations thereof. In some arrangements, the shape memory material members may include an insulating coating.

In some arrangements, the actuator 110 can include a single shape memory material member 120. In some instances, one or more portions of the shape memory material member 120 can extend external to overall envelope of the actuator 110. For instance, the shape memory material member 120 can include a first external portion 121 and a second external portion 122. Further, a portion of the shape memory material member 120 can extend within the actuator 110. Thus, the shape memory material member 120 can include an internal portion 123.

One example of the routing of the shape memory material member 120 will now be described with respect to FIG. 1. Beginning of the left side of FIG. 1, there can be the first external portion 121 of the shape memory material member 120. The shape memory material member 120 can then be routed with respect to the actuator 110. For instance, in some arrangements, the shape memory material member 120 can extend substantially linearly within the actuator 110. In other arrangements, the shape memory material member 120 can extend in a non-linear manner, such as in a serpentine or a zig-zag arrangement. The shape memory material member 120 can exit the actuator 110. This portion is the second external portion 122. In the second external portion, the of the shape memory material member 120 can operatively engage one or more sensors 150.

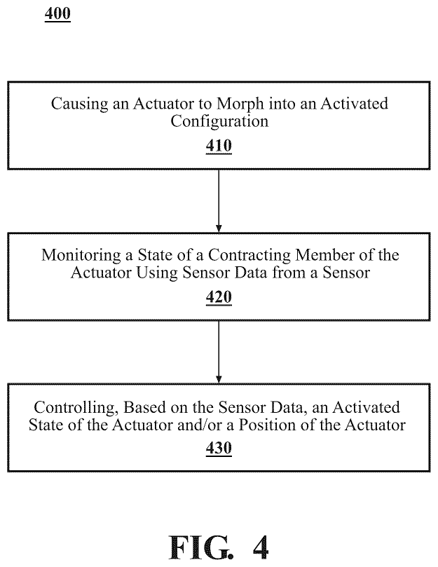

The shape memory material member 120 can be activated and/or deactivated using any suitable form of energy and/or from any suitable source. For example, in some arrangements, the shape memory material member 120 can be operatively connected to a power source (e.g., the power source(s) 240 in FIG. 4). In one or more arrangements, the first external portion 121 can be operatively connected to receive electrical energy (e.g., power in). For instance, the shape memory material member 120 can be operatively connected to a power source at an electrical connection 140. In one or more arrangements, the second external portion 122 can be operatively connected for electrical energy to exit the system 100 (e.g., power out). For instance, the shape memory material member 120 can be operatively connected to a power source at electrical connection 141.

However, it will be appreciated that arrangements described herein are not limited to activating and/or deactivating the shape memory material member 120 based on electrical energy. Indeed, as an example, the shape memory material member 120 can be activated and/or by supplying hot air, such as from a heater or some other heat source, to the shape memory material member 120. The heater can be operatively positioned with respect to the shape memory material member 120.

The shape memory material member can have a plurality of mechanically isolated zones. Each of the mechanically isolated zones does not affect the other mechanically isolated zones. The shape memory material member can be electrically connected throughout its routing. However, if the shape memory material member contracts or expands, then such contraction or expansion occurs through all of the mechanically isolated zones.

The mechanically isolated zones can be defined by a plurality of isolation points. In the example shown in FIG. 1, there can be four isolation points, including a first isolation point 130, a second isolation point 131, a third isolation point 132, and a fourth isolation point 133. The isolation points 130, 131, 132, 133 can be defined in any suitable manner. For instance, the isolation points 130, 131, 132, 133 can be locations where the shape memory material member 120 is crimped. For example, a crimp body can be crushed or deformed about the shape memory material member 120. Some examples of such an arrangement are described in U.S. Patent Application Publication No. 2025/0092862, which is incorporated herein by reference in its entirety.

The isolation points 130, 131, 132, 133 can create a plurality of mechanically isolated zones, including a first mechanically isolated zone 160, a second mechanically isolated zone 161, a third mechanically isolated zone 162, a fourth mechanically isolated zone 163, and a fifth mechanically isolated zone 164. Each of these mechanically isolated zones will be described in turn below.

The first mechanically isolated zone 160 can be defined by the first isolation point 130. The first mechanically isolated zone can include the first external portion 121 of the shape memory material member 120. The first isolation point 130 can be located at or near where the shape memory material member 120 enters the actuator.

The second mechanically isolated zone 161 can be defined between the first isolation point 130 and the second isolation point 131. The second mechanically isolated 161 zone can be largely, if not entirely, defined by the portion of the shape memory material member 120 routed within the actuator 110.

The third mechanically isolated zone 162 can be defined between the second isolation point 131 and the third isolation point 132. The third mechanically isolated zone 162 can be a free-floating zone where the shape memory material member 120 does not engage another structure.

The fourth mechanically isolated zone 163 can be defined between the third isolation point 132 and the fourth isolation point 133. The fourth mechanically isolated zone 163 can be monitored by one or more sensors. The fourth mechanically isolated zone 163 can be where the shape memory material member 120 operatively engages the sensor(s) 150. “Operative engagement” refers to an arrangement in which the activation and/or deactivation of the shape memory material member affects the measurements by and/or the output of the sensor(s) 150. “Operative engagement” can include direct contact and/or indirect contact between the shape memory material member and the sensor(s) 150, including connections without direct physical contact. For instance, the shape memory material member 120 can engage one or more structures to which the sensor(s) 150 is operatively connected. In some arrangements, the sensor(s) 150 can directly physically engage the structure(s). In some arrangements, the sensor(s) 150 can be operatively positioned to observe the structure(s) (e.g., acquire sensor data about without direct physical contact).

The activation and/or deactivation of the shape memory material member can affect the one or more structures in one or more respects, which, in turn, affects the measurements by and/or the output of the sensor(s) 150. In some arrangements, the activation and/or deactivation of the shape memory material member 120 can articulate the structure(s). In some arrangements, the sensor(s) 150 can be operatively positioned to observe or acquire sensor data about the structure(s) or the shape memory material member 120. As an example, the surface of the structure(s) or the shape memory material member 120 can have different appearances when the shape memory material member 120 is at different levels of activation or deactivation.

The fifth mechanically isolated zone 164 can be defined by the fourth isolation point 133 and beyond. The fifth mechanically isolated zone 164 can include the second external portion 122 of the shape memory material member 120. The fourth isolation point 133 can be located at or near where the shape memory material member 120 exits the actuator 110.

The sensor(s) 150 can be any suitable sensor, now known or later developed, that can detect, determine, assess, monitor, measure, quantify, acquire, and/or sense one or more quantities (fundamental or derived) of the contracting member. The quantities can include physical, electrical, photometric, or radiometric quantities. The activation and/or deactivation of the contracting member affects the measurements by and/or the output of the sensor(s) 150. In some arrangements, the sensor(s) 150 can be configured to vary its output signal responsive to changes in the operative engagement by the contracting member. For instance, the sensor(s) 150 can convert an applied force, pressure, tension, weight, etc., into a change in some quantity of the contracting member.

Various non-limiting examples of the sensor(s) 150 will now be described. In one or more arrangements, the sensor(s) 150 can be a capacitive sensor. In one or more arrangements, the sensor(s) 150 can be a thermistor. In such case, the thermistor can, for example, be operatively connected to the contracting member with a spring load bump. Alternatively, the thermistor can be operatively connected to a heat pipe, which is operatively connected to the contracting member. In one or more arrangements, the sensor(s) 150 can be an infrared sensor. In one or more arrangements, the sensor(s) 150 can be a flex sensor (e.g., electro-resistive sensor). In one or more arrangements, the sensor(s) 150 can be a displacement sensor (e.g., a spring with encoded measuring). In one or more arrangements, the sensor(s) 150 can be an on/off affected switch. In one or more arrangements, the sensor(s) 150 can be a current (active or passive) sensor. In one or more arrangements, the sensor(s) 150 can be a strain gauge. In one or more arrangements, the sensor(s) 150 can be a laser sensor, which can detect distance change. In one or more arrangements, the sensor(s) 150 can be a photogate trigger. In one or more arrangements, the sensor(s) 150 can be a thermochromic indicator on wire. In one or more arrangements, the sensor(s) 150 can be a gloss monitor of wire. In one or more arrangements, the sensor(s) 150 can be a phase change pressure monitor. In one or more arrangements, the sensor(s) 150 can be a phase change volume monitor.

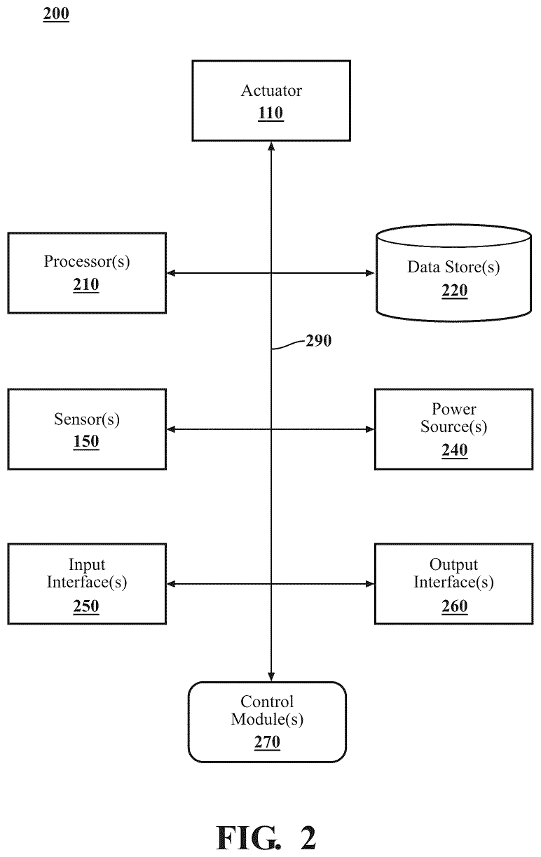

Referring to FIG. 2, an example of a system 200 for position control and/or state monitoring of a contracting member is shown. The system 200 can include various elements. Some of the possible elements of the system 200 are shown in FIG. 2 and will now be described. It will be understood that it is not necessary for the system 200 to have all of the elements shown in FIG. 2 or described herein. The system 200 can have any combination of the various elements shown in FIG. 2. Further, the system 200 can have additional elements to those shown in FIG. 2. In some arrangements, the system 200 may not include one or more of the elements shown in FIG. 2. Further, the elements shown may be physically separated by large distances. Indeed, one or more of the elements can be located remotely from the other elements, such an on a remote server or cloud-based server.

In addition to the actuator 110, the system 200 can include one or more processors 210, one or more data stores 220, one or more sensors 150, one or more power sources 240, one or more input interfaces 250, one or more output interfaces 260, and/or one or more control modules 270. Each of these elements will be described in turn below.

As noted above, the system 200 can include one or more processors 210. “Processor” means any component or group of components that are configured to execute any of the processes described herein or any form of instructions to carry out such processes or cause such processes to be performed. The processor(s) 210 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 210 can include at least one hardware circuit (e.g., an integrated circuit) configured to carry out instructions contained in program code. In arrangements in which there is a plurality of processors 210, such processors can work independently from each other or one or more processors can work in combination with each other.

The system 200 can include one or more data stores 220 for storing one or more types of data. The data store(s) 220 can include volatile and/or non-volatile memory. Examples of suitable data stores 220 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 220 can be a component of the processor(s) 210, or the data store(s) 220 can be operatively connected to the processor(s) 210 for use thereby. The term “operatively connected,” as used throughout this description, can include direct or indirect connections, including connections without direct physical contact.

In some arrangements, the data store(s) 220 can store shape memory material data about one or more shape memory material members. As an example, the data store(s) 220 can store stress-strain curves for one or more contracting members, such as any of those used in the system 100. For each contracting member, the stress-strain curves can show the performance of the respective contracting member. Further, the data store(s) 220 can include values associated with different levels of actuation of the contracting member(s). For instance, there can be a value associated with no actuation, full actuation, and one or more levels of actuation between no actuation and full actuation. The values can correspond to any suitable physical quantity (fundamental or derived) or any property of the contracting member that can be quantified by measurement.

The system 200 can include one or more sensors 150. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process.

In arrangements in which the system 200 includes a plurality of sensors 150, the sensors can work independently from each other. Alternatively, two or more of the sensors can work in combination with each other. In such case, the two or more sensors can form a sensor network. The sensor(s) 150 can be operatively connected to the processor(s) 210, the data store(s) 220, and/or other elements of the system 200 (including any of the elements shown in FIG. 1).

The sensor(s) 150 can include the sensor(s) 150 described in connection with FIG. 1 above. In addition, the sensor(s) 150 can include any suitable type of sensor, now known or later developed, that can acquire information or data about the actuator 110, the contracting member (e.g., the shape memory material member 120), or any other portion or component of the system 100 of FIG. 1.

As noted above, the system 200 can include one or more power sources 240. The power source(s) 240 can be any power source capable of and/or configured to energize the actuator 110 or the contracting member(s) (e.g., the shape memory material member(s) 120) of the actuator 110, as will be described later. For example, the power source(s) 240 can include one or more batteries, one or more fuel cells, one or more generators, one or more alternators, one or more solar cells, and combinations thereof. In some arrangements, the power source(s) 240 can be any suitable source of energy, including electrical energy and/or other forms of energy. In some arrangements, the power source(s) 240 can include a heater or some other heat source.

The system 200 can include one or more input interfaces 250. An “input interface” includes any device, component, system, element or arrangement or groups thereof that enable information/data to be entered into a machine. The input interface(s) 250 can receive an input from a vehicle occupant (e.g., a driver or a passenger). Any suitable input interface 250 can be used, including, for example, a keypad, gesture recognition interface, voice recognition interface, display, touch screen, multi-touch screen, button, joystick, mouse, trackball, microphone and/or combinations thereof.

The system 200 can include one or more output interfaces 260. An “output interface” includes any device, component, system, element or arrangement or groups thereof that enable information/data to be presented to a vehicle occupant (e.g., a person, a vehicle occupant, etc.). The output interface(s) 260 can present information/data to a vehicle occupant. The output interface(s) 260 can include a display. Alternatively or in addition, the output interface(s) 260 may include an earphone and/or speaker. Some components of the system 200 may serve as both a component of the input interface(s) 250 and a component of the output interface(s) 260.

The system 200 can include one or more modules, at least some of which will be described herein. The modules can be implemented as computer readable program code that, when executed by a processor, implements one or more of the various processes described herein. One or more of the modules can be a component of the processor(s) 210, or one or more of the modules can be executed on and/or distributed among other processing systems to which the processor(s) 210 is operatively connected. The modules can include instructions (e.g., program logic) executable by one or more processor(s) 210. Alternatively or in addition, one or more data stores 220 may contain such instructions. In some arrangements, the module(s) can be located remote from the other elements of the system 200.

In one or more arrangements, the modules described herein can include artificial or computational intelligence elements, e.g., neural network, fuzzy logic or other machine learning algorithms. Further, in one or more arrangements, the modules can be distributed among a plurality of modules. In one or more arrangements, two or more of the modules described herein can be combined into a single module.

The system 200 can include one or more control modules 270. The control module(s) 270 can include profiles and logic for controlling the actuator 110. The control module(s) 270 can use profiles, parameters, or settings loaded into the control module(s) 270 and/or stored in the data store(s) 220, such as the actuation profiles. In some arrangements, the control module(s) 270 can be located remotely from the other elements of the system 200, such as on a remote server, a cloud-based server, or an edge server.

The control module(s) 270 can be configured to cause one or more of the actuators 110 to be activated or deactivated. As used herein, “cause” or “causing” means to make, force, compel, direct, command, instruct, and/or enable an event or action to occur or at least be in a state where such event or action may occur, either in a direct or indirect manner. For instance, the control module(s) 270 can cause the actuator 110 to be selectively activated or deactivated in any suitable manner. For instance, when the actuator 110 includes a shape memory material member 120, the shape memory material member 120 can be heated by the Joule effect by passing electrical current through the shape memory material member. To that end, the control module(s) 270 can be configured to selectively permit, restrict, adjust, alter, and/or prevent the flow of electrical energy from the power source(s) 240 to the shape memory material member 120 of the actuator 110. The control module(s) 270 can be configured to send control signals or commands over a communication network 290 to one or more elements of the system 200.

The control module(s) 270 can be configured to cause the actuator 110 to be activated or deactivated based on various events, conditions, inputs, or other factors. For instance, the control module(s) 270 can be configured to cause the actuator 110 to be activated or deactivated based on a user input. A user can provide an input on the input interface(s) 250.

In some arrangements, the control module(s) 270 can be configured to cause the actuator 110 to be activated or deactivated. In some instances, the control module(s) 270 can be configured to adjust the degree of activation of the actuator 110. For instance, the control module(s) 270 can be configured to cause the actuator 110 to be in an activated configuration that corresponds to its full activated position (e.g., extended to its maximum height). The control module(s) 270 can be configured to activate the actuator 110 to one or more activated configurations between the non-activated configuration and the full activated configuration, such as an extended position but less than its maximum height. The control module(s) 270 can be configured to maintain the activated configuration of the actuator 110. The control module(s) 270 can be configured to adjust the activated configuration of the actuator 110.

The control module(s) 270 can be configured to receive sensor data from the sensor(s) 150. The control module(s) 270 can be configured to analyze the sensor data. For instance, the control module(s) 270 can be configured to determine a state, attribute, characteristic, quality, indicator, metric, and/or parameter of the contracting member based on the output signals/sensor data from the sensor(s) 150. The control module(s) 270 can be configured to compare the output signals/sensor data from the sensor(s) 150 to known data about the contracting member at different actuation levels, which can be stored in the data store(s) 220. Such comparing can be beneficial in achieving position control of the actuator 110. When the control module(s) 270 detect that the output signals/sensor data from the sensor(s) 150 matches a desired actuation level, the control module(s) 270 can be configured to take one or more actions. For instance, the control module(s) 270 can maintain the current state of the actuator 110. Thus, additional power is not supplied to the contracting member. In this way, extra power is not supplied to the to the contracting member and, therefore, is not wasted.

In some arrangements, the control module(s) 270 can be configured to detect changes in the output signals/sensor data from the sensor(s) 150. In at least some instances, once the output signals/sensor data from the sensor(s) 150 stops changing, then the control module(s) 270 can recognize that the contracting member has reached its critical temperature and/or the actuator 110 is at its maximum activated configuration.

When the contracting member is activated, it can contract. This contraction can affect the sensor. As a result, a quality of the contracting member can be measured. The absolute value of the quality does not have to be known. The change in the quality can be monitored over time. When the quality no longer changes, then the contracting member is in its maximum activated or non-activate state, depending on whether the contracting member is in heating cycle or a cooling cycle. When this point is reached, the control module(s) 270 can turn off power to the contracting member (in a heating cycle) or turn on the power to the contracting member (in a cooling cycle). Alternatively, in a heating cycle, the control module(s) 270 can cause the current state of the actuator to be maintained so that extra power is not supplied to the contracting member. Alternatively, in a cooling cycle, the control module(s) 270 can alter the cooling of the contracting member, such as by turning off one or more fans, reducing the speed of one or more fans, or combinations thereof.

When the output signals/sensor data from the sensor(s) 150 correspond to resistance, the resistance will stop changing once the critical temperature is reached, even if the shape memory material member 120 is heated beyond the critical temperature. Thus, in this example, the actual value of the resistance of the sensor(s) 150 does not have to be known. Rather, the control module(s) 270 only needs to monitor the changes in electrical resistance. When the control module(s) 270 detect that the resistance is no longer changing, the control module(s) 270 can be configured to take one or more actions. For instance, the control module(s) 270 can discontinue the supply of electrical energy to the shape memory material member 120. Alternatively, the control module(s) 270 can maintain the current state of the actuator 110. Thus, additional power is not supplied to the shape memory material member 120. In this way, extra power is not supplied to the to the shape memory material member 120 and, therefore, is not wasted.

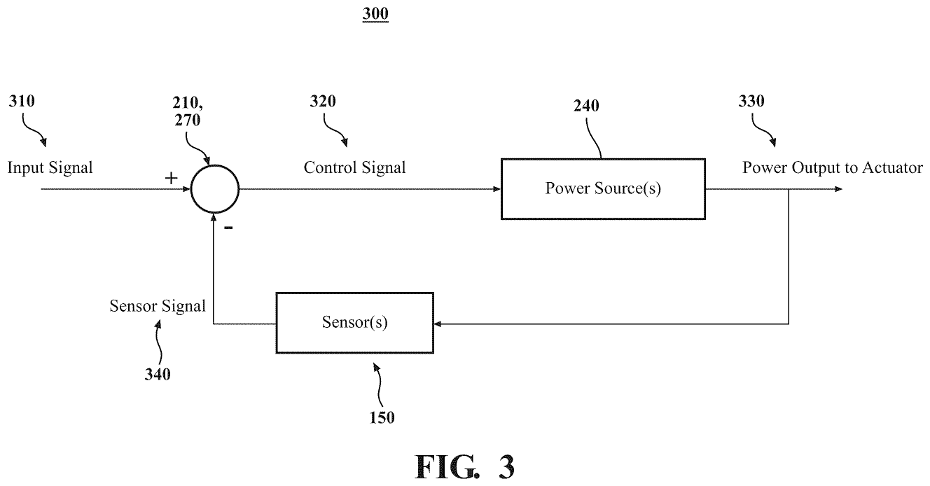

FIG. 3 is an example of a control scheme 300 for a system for monitoring a state of a contracting member. The control scheme 300 can be implemented by the control module(s) 270. An input signal 310 can be provided to the control module(s) 270 and/or processor(s) 210. The input signal 310 can be sent from any suitable source. For instance, the input signal 310 can be generated by user such as using a sliding potentiometer, or the input signal 310 can be generated by an external controller/computer. The input signal 310 can be a software signal from a program.

The control module(s) 270 and/or processor(s) 210 can send a control signal 320. The control signal 320 can be used to control a power supply 330 (e.g., power source(s) 240) based on the difference between a sensor signal 340 and the input signal 310. For instance, if an input signal 310 is for a different amount than the current status of the shape memory material member, as evidence by the sensor signal 340, then the control module(s) 270 can adjust the supply of energy from the power source(s) 240 to the shape memory material member 120 to compensate for the difference between the input signal 310 and the sensor signal 340. The control module(s) 270 can hold the shape memory material member 120 in that position. The control signal 320 can be either a binary signal or variable signal depending on the setup.

The power supply 330 can be a power supply of electrical energy. The power supply 330 can have either a constant voltage or a variable voltage based on the control signal 320. The power supply 330 can provide a power output to the actuator 110. As the power output to the actuator 110 changes, it affects the sensor signals 340 output by the strain gauge 155. The sensor signals 340 can be sent to the processor(s) 210 and/or the control module(s) 270.

Arrangements described herein can enable precise position control of the actuator 110 and/or state monitoring of the shape memory material member 120 or other contracting member. In some arrangements, the monitoring and position control can be achieved using a single sensor. In some arrangements, position control can be achieved based on a slider potentiometer position.

With position control, the actuator 110 can move to and hold at a specific position using the control scheme 300 and the sensor signal 340 feedback from the sensor(s) 150. The sensor signal 340 can also provide additional information on the status of the contracting member, which can be used to prevent the contracting member from burning or overheating.

It will be appreciated that arrangements described herein are not limited to strain gauges or to monitoring strain or changes in strain. Indeed, arrangements described herein can be configured to monitor the state of the contracting member (e.g., shape memory material members 120) based on any sensor data. Such monitoring can be based on any state, attribute, characteristic, quality, indicator, metric, and/or parameter. The control module(s) 270 can be configured to determine when at least one metric is fulfilled based on feedback from one or more of the sensor(s) 150.

The various elements of the system 200 can be communicatively linked to one another or one or more other elements through one or more communication networks 290. As used herein, the term “communicatively linked” can include direct or indirect connections through a communication channel, bus, pathway or another component or system. A “communication network” means one or more components designed to transmit and/or receive information from one source to another. The data store(s) 220 and/or one or more other elements of the system 200 can include and/or execute suitable communication software, which enables the various elements to communicate with each other through the communication network and perform the functions disclosed herein.

The one or more communication networks 290 can be implemented as, or include, without limitation, a wide area network (WAN), a local area network (LAN), the Public Switched Telephone Network (PSTN), a wireless network, a mobile network, a Virtual Private Network (VPN), the Internet, a hardwired communication bus, and/or one or more intranets. The communication network 290 further can be implemented as or include one or more wireless networks, whether short range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long range (e.g., a mobile, cellular, and/or satellite-based wireless network; GSM, TDMA, CDMA, WCDMA networks or the like). The communication network 290 can include wired communication links and/or wireless communication links. The communication network 290 can include any combination of the above networks and/or other types of networks.

Now that the various potential systems, devices, elements and/or components of the system 200 have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

Turning to FIG. 4, an example of a method 400 of position control and/or state monitoring a contracting member is shown. At block 410, the actuator 110 can be caused to morph into an activated configuration. Such causing can be performed by the processor(s) 210 and/or the control module(s) 270. For instance, the processor(s) 210 and/or the control module(s) 270 can cause electrical energy from the power source(s) 240 to be supplied to the plurality of actuators 110. More particularly, the processor(s) 210 and/or the control module(s) 270 can cause electrical energy from the power source(s) 240 to be supplied to the contracting member (e.g., the shape memory material member 120) of the actuator 110. As a result, the shape memory material member 120 can contract, which morphs the actuator 110 into the activated configuration where a height of the actuator 110 can increase. The causing can be performed automatically, in response to a user input (e.g., provided on the input interface(s) 250), or in any other suitable way. The method 400 can continue to block 420.

At block 420, a state of the shape memory material member 120 can be monitored. The monitoring can be performed by the control module(s) 270 and/or the processor(s) 210 based on sensor data acquired by the sensor(s) 150. In one or more arrangements, the control module(s) 270 and/or the processor(s) 210 can monitor sensor data of the sensor(s) 150 . . . . In one or more arrangements, the control module(s) 270 and/or the processor(s) 210 can monitor for changes in values of measurements by the sensor(s) 150. In some arrangements, the control module(s) 270 can compare the sensor signals 340 output by the sensor(s) 150 to an input signal 310 provided to the control module(s) 270. In one or more arrangements, the control module(s) 270 and/or the processor(s) 210 can monitor when the measurements or output of the sensor(s) 150 reached a predetermined level. In some arrangements, the control module(s) 270 and/or the processor(s) 210 can compare the sensor signals or data from the sensor(s) 150 to data or information in the data store(s) 220. In one or more arrangements, the control module(s) 270 and/or the processor(s) 210 can monitor when the measurements by or values output from of the sensor(s) 150 stop changing. The method 400 can continue to block 430.

At block 430, the activated configuration of the actuator 110 and/or a position of the actuator 110 can be controlled based on the monitored state of the shape memory material member 120. The controlling can be performed by the control module(s) 270 and/or the processor(s) 210. As an example, when the measurements by or values output from of the sensor(s) 150 stop changing, the control module(s) 270 and/or the processor(s) 210 can cause the supply of electrical energy to the shape memory material member 120 to be discontinued.

As another example, when the measurements by or values output from of the sensor(s) 150 stop changing and/or reaches a desired level, the control module(s) 270 can maintain the current state of the actuator 110. Thus, the control module(s) 270 and/or the processor(s) 210 can cause the supply of energy to the shape memory material member 120 to be maintained at the present level. In this way, a position of the actuator 110 can be controlled. Such controlling can be performed by the control module(s) 270 and/or the processor(s) 210. Such controlling can be based on sensor data from the sensor(s) 150.

In at least some arrangements, the output signals of the sensor(s) 150 can stop changing once the critical temperature is reached, even if the shape memory material member 120 is heated beyond the critical temperature. Thus, once the measurements by or values output from of the sensor(s) 150 stop changing, then the control module(s) 270 can recognize that the shape memory material member has reached its critical temperature and that the actuator 110 is at its maximum activated configuration.

Thus, at least in some respects, the actual value of the measurements by or values output from of the sensor(s) 150 does not have to be known. Rather, the control module(s) 270 only needs to monitor the changes in the output signals of the sensor(s) 150. When the control module(s) 270 detects that the output signals are no longer changing, the control module(s) 270 can be configured to take one or more actions. For instance, the control module(s) 270 can discontinue the supply of electrical energy to the shape memory material member 120. Alternatively, the control module(s) 270 can maintain the current state of the actuator 110. Thus, additional power is not supplied to the shape memory material member 120. In this way, extra power is not supplied to the to the shape memory material member 120 and, therefore, is not wasted.

The method 400 can end. Alternatively, the method 400 can return to block 410 or to some other block. The method 400 can be repeated at any suitable point, such as at a suitable time or upon the occurrence of any suitable event or condition. In some instances, the method 400 can include additional blocks.

As noted above, arrangements described herein can be used in connection there can be a plurality of actuators. The actuators can be substantially identical to each other. Alternatively, one or more of the actuators can be different from the other actuators in one or more respects. FIGS. 5-9 show some non-limiting examples of suitable actuators.

FIGS. 5A-5C show one example of an actuator 500 suitable for use in connection with arrangements described herein. The basic details of the actuator 500 will now be described. Additional details of the actuator 500 are described in U.S. Pat. No. 10,960,793, which is incorporated herein by reference in its entirety.

The actuator 500 is depicted here with an outer skin 510, hinge assemblies 520, and an input-responsive element 530. The actuator 500 can have a first dimension 540 and a second dimension 550.

The input-responsive element 530 can include one or more elements capable of transitioning from a first configuration to a second configuration. The transition of the input-responsive element 530 from the first configuration to the second configuration displaces the hinge assemblies 520 with respect to the outer skin 510 and causes a change in confirmation of the outer skin 510. In some implementations, the input-responsive element 530 can include a SMM wire 532. The SMM wire 532 can be a shape memory alloy.

FIG. 5A shows an example of the actuator 500 in a non-activated configuration. When heated, the SMM wire 532 can contract, causing the hinge assemblies 520 to move toward one another. As a result, the actuator 500 can morph from a non-activated configuration to an activated configuration as shown in FIG. 5C. In the activated configuration, the second dimension 550 of the actuator can increase, and the first dimension 540 of the actuator 500 can decrease.

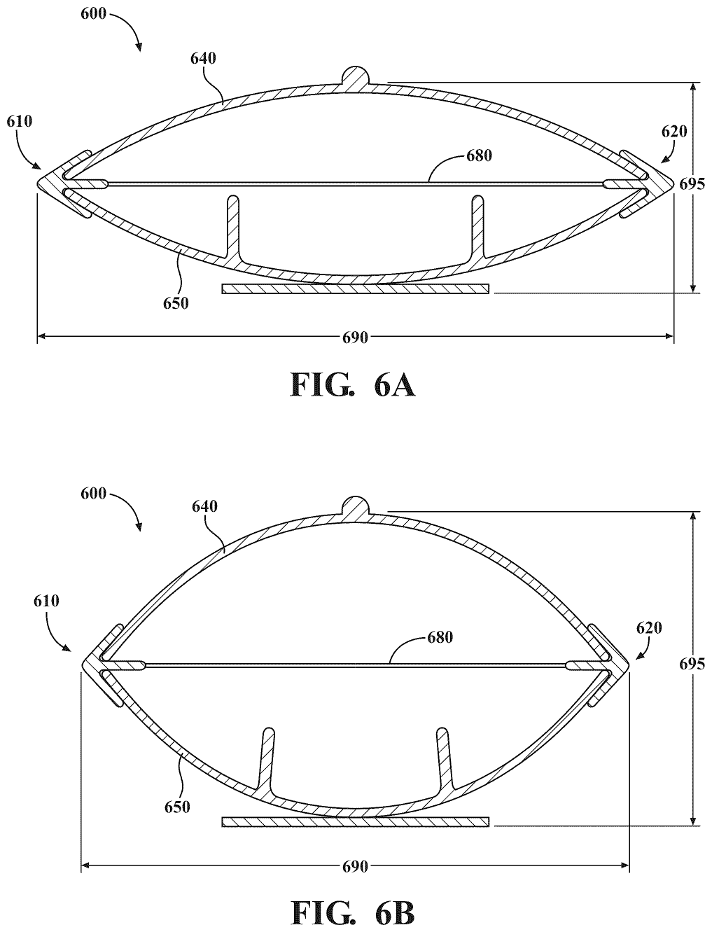

FIGS. 6A-6B show another example of an actuator 600 suitable for use in connection with arrangements described herein. The basic details of the actuator 600 will now be described. Additional details of the actuator 600 are described in U.S. Pat. No. 12,383,066, which is incorporated herein by reference. FIG. 6A shows an example of the actuator 600 in a non-activated condition, and FIG. 6B shows an example of the actuator 600 in an activated condition.

The actuator 600 can include a first endcap 610 and a second endcap 620. The first endcap 610 and the second endcap 620 can be spaced apart. The actuator 600 can include a first outer member 640 and a second outer member 650. The first outer member 640 and the second outer member 650 can have a bowed shape.

The actuator 600 can include one or more shape memory material members 680. The shape memory material members 680 can be operatively connected to the first endcap 610 and the second endcap 620. The phrase “shape memory material” includes materials that changes shape when an activation input is provided to the shape memory material and, when the activation input is discontinued, the material substantially returns to its original shape. Examples of shape memory materials include shape memory alloys (SMA) and shape memory polymers (SMP).

In one or more arrangements, the shape memory material members 680 can be shape memory material wires. As an example, the shape memory material members 680 can be shape memory alloy wires. Thus, when an activation input (i.e., heat) is provided to the shape memory alloy wire(s), the wire(s) can contract. Shape memory alloy wire(s) can be heated in any suitable manner, now known or later developed. For instance, shape memory alloy wire(s) can be heated by the Joule effect by passing electrical current through the wires. In some instances, arrangements can provide for cooling of the shape memory alloy wire(s), if desired, to facilitate the return of the wire(s) to a non-activated configuration.

As noted above, FIG. 6B is an example of the actuator 600 in an activated condition. When an activation input (e.g., electrical energy) is provided to the shape memory material member(s) 680, the shape memory material member(s) 680 can contract. This contraction causes the shape memory material member(s) 680 to pull the first endcap 610 and the second endcap 620 toward each other in a direction that corresponds to the first dimension 690.

Consequently, the ends of the first outer member 640 can be drawn toward each other in a direction that corresponds to the first dimension 690, and the ends of the second outer member 650 can be drawn toward each other in a direction that corresponds to the first dimension 690. As a result, the first outer member 640 and the second outer member 650 can bow outward and away from each other in a direction that corresponds to the second dimension 695. It will be appreciated that the first dimension 690 (i.e., the width) of the actuator 600 can decrease, and the second dimension 695 (i.e., the height) of the actuator 600 can increase.

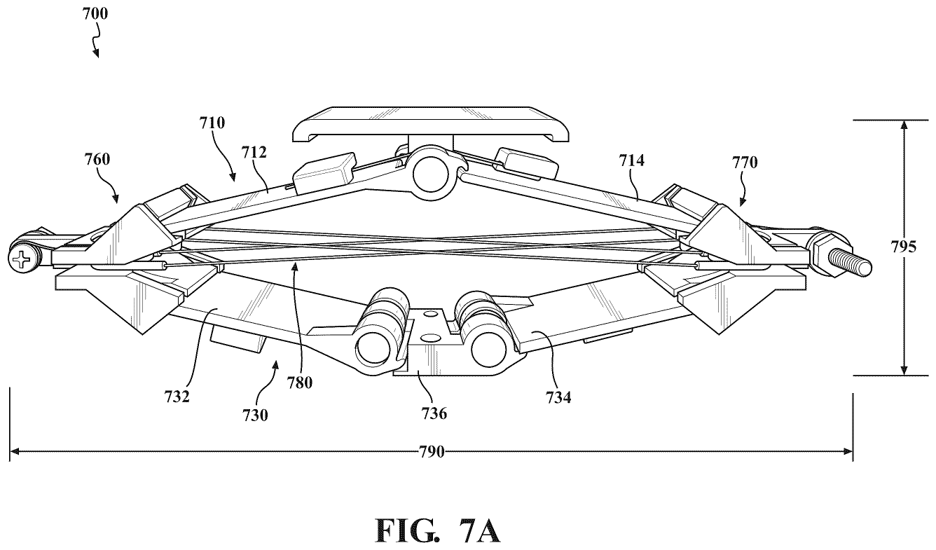

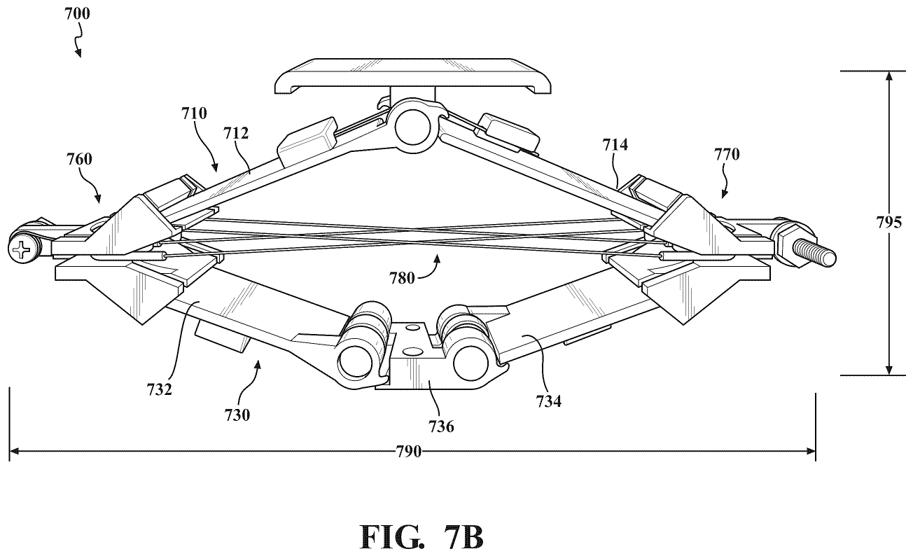

FIGS. 7A-7B show one example of an actuator 700 suitable for use according to arrangements herein. The basic details of the actuator 700 will now be described. Additional details of the actuator 700 are described in U.S. Pat. No. 12,270,386, which is incorporated herein by reference.

The actuator 700 can include a first outer body member 710, a second outer body member 730, a first endcap 760, a second endcap 770, and a shape memory material member 780. The first outer body member 710 can include a first portion 712 and a second portion 714. The first portion 712 and the second portion 714 can be operatively connected to each other such that the first portion 712 and the second portion 714 can move relative to each other. In one or more arrangements, the first portion 712 and the second portion 714 can be pivotably connected to each other. For example, the first portion 712 and the second portion 714 can be pivotably connected to each other by one or more hinges. The first portion 712 and the second portion 714 can be angled relative to each other. As a result, the first outer body member 710 can have a generally V-shape.

The second outer body member 730 can include a first portion 732, a second portion 734, and a base 736. In one or more arrangements, each of the first portion 732 and the second portion 734 can be pivotably connected to the base 736. For example, the first portion 732 can be pivotably connected to the base 736 by one or more hinges, and the second portion 734 can be pivotably connected to the base 736 by one or more hinges. The first portion 732 and the second portion 734 can be located on opposite sides of the base 736.

The actuator 700 can include a first endcap 760 and a second endcap 770. The first endcap 760 and the second endcap 770 can be spaced apart. The actuator 700 can include one or more shape memory material members 780. The shape memory material member(s) 780 can extend between the first endcap 760 and the second endcap 770 in any suitable manner. The shape memory material member(s) 780 can be operatively connected to the first endcap 760 and the second endcap 770.

FIG. 7A shows an example of the actuator 700 in a non-activated configuration. Here, the shape memory material member(s) 780 are not activated. FIG. 7B shows an example of the actuator 700 in an activated configuration. When an activation input (e.g., electrical energy) is provided to the shape memory material member(s) 780, the shape memory material member(s) 780 can contract. This contraction causes the shape memory material member(s) 780 to pull the first endcap 760 and the second endcap 770 toward each other in a direction that corresponds to a first dimension 790. As a result, the first outer body member 710 and the second outer body member 730 can extend outward and away from each other in a direction that corresponds to a second dimension 795. It will be appreciated that, in going from the non-activated condition to the activated condition, the first dimension 790 (i.e., the width) of the actuator 700 can decrease and/or the second dimension 795 (i.e., the height) of the actuator 700 can increase. Further, it will be appreciated that the actuator 700 can deliver a force in a direction that is out of plane or otherwise different from the direction of contraction of the shape memory material member(s) 780.

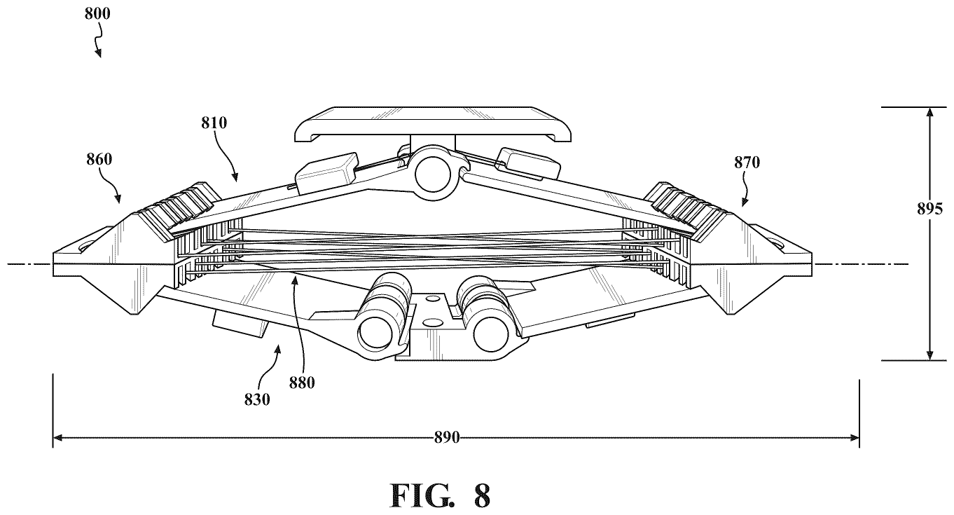

FIG. 8 shows one example of an actuator 800 suitable for use according to arrangements herein. The basic details of the actuator 800 will now be described. Additional details of the actuator 800 are described in U.S. Pat. No. 12,270,386, which is incorporated herein by reference.

The actuator 800 can include a first outer body member 810, a second outer body member 830, and one or more shape memory material members 880. The actuator 800 includes a first endcap 860 and a second endcap 870. The first endcap 860 and the second endcap 870 shown in FIG. 8 are different than the first endcap 760 and the second endcap 770 shown in FIGS. 7A-7B.

FIG. 8 shows an example of the actuator 800 in a non-activated configuration. Here, the shape memory material member(s) 880 are not activated. When an activation input (e.g., electrical energy) is provided to the shape memory material member(s) 880, the shape memory material member(s) 880 can contract. This contraction causes the shape memory material member(s) 880 to pull the first endcap 860 and the second endcap 870 toward each other in a direction that corresponds to the first dimension 890. As a result, the first outer body member 810 and the second outer body member 830 can extend outward and away from each other in a direction that corresponds to the second dimension 895. It will be appreciated that, in going from the non-activated condition to the activated condition, the first dimension 890 (i.e., the width) of the actuator 800 can decrease and/or the second dimension 895 (i.e., the height) of the actuator 800 can increase.

FIG. 8 shows an example of the actuator 800 in a non-activated configuration. Here, the shape memory material member(s) 880 are not activated. When an activation input (e.g., electrical energy) is provided to the shape memory material member(s) 880, the shape memory material member(s) 880 can contract. This contraction causes the shape memory material member(s) 880 to pull the first endcap 860 and the second endcap 870 toward each other in a direction that corresponds to the first dimension 890. As a result, the first outer body member 810 and the second outer body member 830 can extend outward and away from each other in a direction that corresponds to the second dimension 895. It will be appreciated that, in going from the non-activated condition to the activated condition, the first dimension 890 (i.e., the width) of the actuator 800 can decrease and/or the second dimension 895 (i.e., the height) of the actuator 800 can increase.

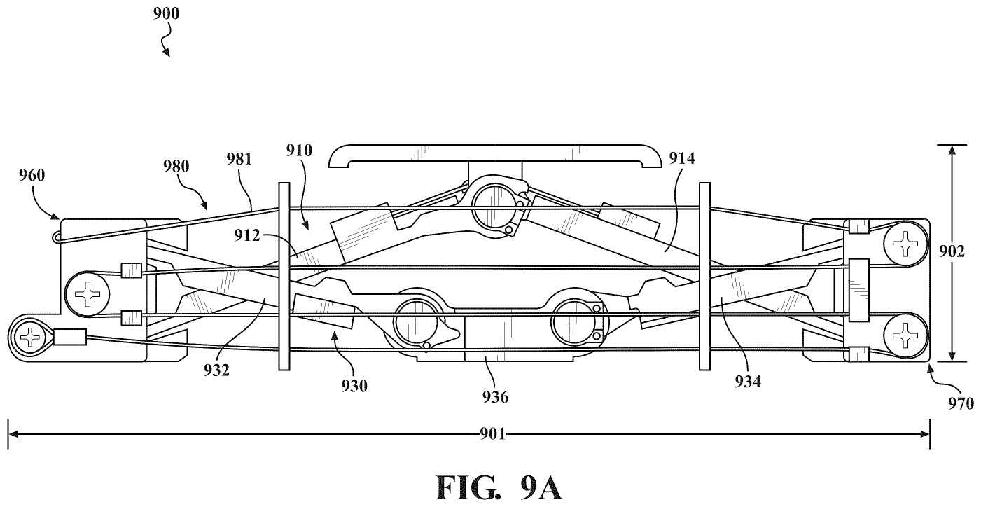

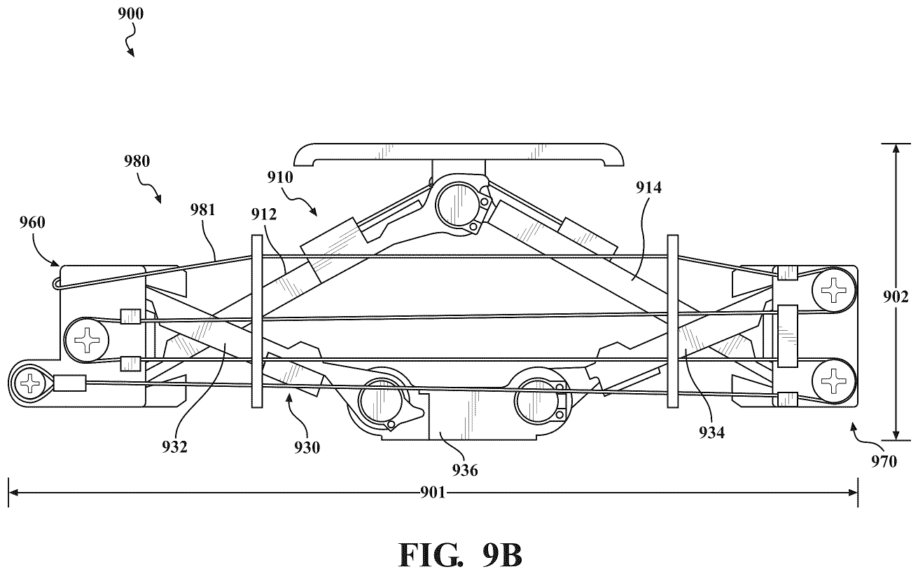

FIGS. 9A-9B shows one example of an actuator 900 suitable for use according to arrangements herein. The basic details of the actuator 900 will now be described. Additional details of the actuator 900 are described in U.S. Pat. No. 12,241,458, which is incorporated herein by reference.

The actuator 900 can include a first outer body member 910, a second outer body member 930, a first endcap 960, a second endcap 970, and a contracting member 980, which can be a shape memory material member 981. The first outer body member 910 can include a first portion 912 and a second portion 914. The first portion 912 and the second portion 914 can be operatively connected to each other such that the first portion 912 and the second portion 914 can move relative to each other. In one or more arrangements, the first portion 912 and the second portion 914 can be pivotably connected to each other. For example, the first portion 912 and the second portion 914 can be pivotably connected to each other by one or more hinges. The first portion 912 and the second portion 914 can be angled relative to each other. As a result, the first outer body member 910 can have a generally V-shape.

The second outer body member 930 can include a first portion 932, a second portion 934, and a base 936. In one or more arrangements, each of the first portion 932 and the second portion 934 can be pivotably connected to the base 936. For example, the first portion 932 can be pivotably connected to the base 936 by one or more hinges, and the second portion 934 can be pivotably connected to the base 936 by one or more hinges. The first portion 932 and the second portion 934 can be located on opposite sides of the base 936.

The first outer body member 910 the second outer body member 930 can be arranged in a scissored configuration. In one or more arrangements, a portion of the first outer body member 910 can cross a portion of the second outer body member 930. More particularly, the first portion 912 of the first outer body member 910 and the first portion 932 of the second outer body member 930 can cross each other. Alternatively or additionally, the second portion 914 of the first outer body member 910 and the second portion 934 of the second outer body member 930 can cross each other. In one or more arrangements, the first portion 912 of the first outer body member 910 can pass through the first portion 932 of the second outer body member 930 and/or the second portion 914 of the first outer body member 910 can pass through the second portion 934 of the second outer body member 930. Of course, it will be appreciated that, in other arrangements, the first portion 932 of the second outer body member 930 can pass through the first portion 912 of the first outer body member 910 and/or the second portion 934 of the second outer body member 930 can pass through the second portion 914 of the first outer body member 910.

The actuator 900 can include a first endcap 960 and a second endcap 970. The first endcap 960 and the second endcap 970 can be spaced apart. The actuator 900 can include one or more contracting member(s) 980 (e.g., one or more shape memory material members 981). The contracting member(s) 980 can extend between the first endcap 960 and the second endcap 970 in any suitable manner. The contracting member(s) 980 can be operatively connected to the first endcap 960 and the second endcap 970.

FIG. 9A shows an example of the actuator 900 in a non-activated configuration. Here, the contracting member(s) 980 are not activated. FIG. 9B shows an example of the actuator 900 in an activated configuration. When an activation input (e.g., energy, electrical energy, heat, etc.) is provided to the contracting member(s) 980, the contracting member(s) 980 can contract. This contraction causes the contracting member(s) 980 to pull the first endcap 960 and the second endcap 970 toward each other in a direction that corresponds to the first dimension 901. As a result, the first outer body member 910 and the second outer body member 930 can extend outward and away from each other in a direction that corresponds to the second dimension 902. It will be appreciated that, in going from the non-activated condition to the activated condition, the first dimension 901 (i.e., the width) of the actuator 900 can decrease and/or the second dimension 902 (i.e., the height) of the actuator 900 can increase. Further, it will be appreciated that the actuator 900 can deliver a force in a direction that is out of plane or otherwise different from the direction of contraction of the contracting member(s) 980.

The various examples of actuators shown in FIGS. 5-9 are merely examples and are not intended to be limiting. Other actuators are described in U.S. Pat. Nos. 10,960,793; 11,370,330; 11,285,844; 11,091,060; 11,603,828; 11,752,901; 11,897,379; 12,152,570; 12,163,507; 12,241,458; 12,270,386; and 12,383,066, which are incorporated herein by reference in their entireties. Additional actuators are described in U.S. Patent Publication Nos. 2023/0191953; 2023/0136197; 2025/0172130; 2025/0058679; 2025/0058688; 2025/0065787; 2025/0065777; 2025/0092862; and 2025/0214265, which are incorporated herein by reference in their entireties. Still further actuators are described in U.S. Patent Application Nos. 63/850,102 and 63/623,930, which are incorporated herein by reference in their entireties. Arrangements described herein can be used in connection with any of the actuators described in the above-noted references.

Further, additional example of state monitoring and/or position control of a contracting member are described in U.S. Pat. No. 12,234,811 and U.S. patent application Ser. No. 18/758,043, which are incorporated herein by reference in their entireties.

Arrangements described herein can be used in any application in which shape memory material-based actuators are used. For instance, arrangements described herein can be used in connection with seat actuators or other actuators in a vehicle. “Vehicle” means any form of transport, including motorized or powered transport. In one or more implementations, the vehicle can be an automobile. While arrangements will be described herein with respect to automobiles, it will be understood that embodiments are not limited to automobiles. In some implementations, the vehicle may be a watercraft, an aircraft, spacecraft, or any other form of transport. However, it will be appreciated that arrangements described herein are not limited to vehicular applications. For instance, arrangements described herein can be used in connection with an office chair, a chair, a massage chair, a gaming chair, a recliner, or any other seat structure, now known or later developed. Of course, arrangements are not limited to seat applications. Arrangements described herein can be used as massage actuator, lumbar support or any other robotic/actuator applications that requires position control.

It will be appreciated that arrangements described herein can provide numerous benefits, including one or more of the benefits mentioned herein. For example, arrangements described herein can provide a cost-effective way to monitor the state of a contracting member. Arrangements described herein can enable detection of the maximum actuated state of a contracting member. Arrangements described herein can enable indirect measurement of a maximum actuated state of the contracting member. Arrangements described herein can determine when an effectively heated or cooled state of the contracting member is reached. Arrangements described herein can enable such detection using inexpensive sensors. Arrangements described herein can use any suitable sensor, thereby enabling a sensor agnostic system. Arrangements described herein can protect contracting members from overheating, overcooling, and/or overstressing. Arrangements described herein can help to maximize the useful life of a contracting member. Arrangements described herein can facilitate improved actuator performance. Arrangements described herein can enable precise control of a contracting member-based actuator to achieve and/or maintain a specific position. Arrangements described herein can facilitate the use of a sensor with no calibration needed.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “or” is intended to mean an inclusive “or” rather than an exclusive “or.” The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
an actuator configured to morph, when activated, into an activated configuration in which a dimension of the actuator increases, the actuator including a contracting member;
a sensor configured to acquire or output sensor data, the contracting member operatively engaging the sensor; and
a processor operatively connected to monitor a state of the contracting member based on the sensor data.

2. The system of claim 1, wherein the sensor includes a capacitive sensor, a thermistor, an infrared sensor, a flex sensor, a displacement sensor, an on/off affected switch, a current (active or passive) sensor, a strain gauge, a laser sensor, a photogate trigger, thermochromic indicator, a gloss monitor, a phase change pressure monitor, or a phase change volume monitor.

3. The system of claim 1, wherein the contracting member includes an external portion that extends external to the actuator.

4. The system of claim 3, wherein the external portion of the contracting member operatively engages the sensor.

5. The system of claim 1, wherein the contracting member directly physically engages the sensor.

6. The system of claim 1, wherein the contracting member engages a structure to which the sensor is operatively connected or operatively positioned to observe.

7. The system of claim 1, wherein the contracting member is a shape memory material member.

8. The system of claim 7, wherein the shape memory material member is a shape memory alloy.

9. The system of claim 7, wherein the shape memory material member is a wire.

10. The system of claim 1, wherein the processor is configured to one of:
control a position of the actuator using the sensor data; or
control the state of the contracting member using the sensor data.

11. The system of claim 10, wherein, when at least one metric is fulfilled based on sensor data, the processor is configured to discontinue a supply of energy to the contracting member.

12. The system of claim 10, wherein, when at least one metric is fulfilled based on sensor data, the processor is configured to substantially maintain a supply of energy to the contracting member at a present level.

13. The system of claim 1, wherein the contracting member includes a plurality of mechanically isolated zones, the plurality of mechanically isolated zones being defined by a plurality of isolation points along the contracting member.

14. The system of claim 13, wherein the plurality of isolation points are areas where the contracting member is crimped.

15. The system of claim 13, wherein the contracting member operatively engages the sensor in one of the plurality of mechanically isolated zones that is external to the actuator.

16. A method of monitoring a state of a contracting member used in an actuator, the contracting member operatively engaging a sensor, the method comprising:
causing the actuator to morph into an activated configuration;
monitoring a state of the contracting member using sensor data from the sensor; and
controlling, based on the sensor data, at least one of:
an activated state of the actuator; and
a position of the actuator.

17. The method of claim 16, wherein the sensor includes a capacitive sensor, a thermistor, an infrared sensor, a flex sensor, a displacement sensor, an on/off affected switch, a current (active or passive) sensor, a strain gauge, a laser sensor, a photogate trigger, thermochromic indicator, a gloss monitor, a phase change pressure monitor, or a phase change volume monitor.

18. The method of claim 16, wherein controlling an activated state of the actuator based on the sensor data includes:
discontinuing a supply of energy to the contracting member when at least one metric is fulfilled based on the sensor data.

19. The method of claim 16, wherein controlling an activated state of the actuator based on the sensor data includes:
substantially maintaining a supply of electrical energy to the contracting member when at least one metric is fulfilled based on the sensor data.

20. The method of claim 16, wherein the contracting member directly physically engages the sensor.

21. The method of claim 16, wherein the contracting member engages a structure to which the sensor is operatively connected or operatively positioned to observe.
